(19) United States
(12) Patent Application Publication
(10) Pub. No.: US 2012/0281979 A1
(43) Pub. Date: Nov. 8, 2012

(54) OPTICAL NETWORK WITH LIGHT-PATH AGGREGATION

(75) Inventors: Tiejun J. Xia, Richardson, TX (US); Glenn A. Wellbrock, Wylie, TX (US)

(73) Assignee: VERIZON PATENT AND LICENSING INC., Basking Ridge, NJ (US)

(21) Appl. No.: 13/099,662

(22) Filed: May 3, 2011

(51) Int. Cl. H04J 14/00; H04B 10/08

(52) U.S. Cl. 398/25; 398/43

(57) ABSTRACT

A method comprising identifying a data demand of an optical channel request; identifying available resources for satisfying the optical channel request; selecting light paths to a destination based on the identified available resources, wherein each light path is distinct; selecting one or more optical carriers for each light path; optically transmitting data pertaining to the optical channel request based on the selected light paths, wherein each selected optical carrier of each light path carries a portion of the data and a total of the one or more optical carriers associated with the light paths collectively carry an entire portion of the data; receiving the one or more optical carriers of the light paths at the destination; identifying a latency between the one or more optical carriers of the light paths; adjusting the latency between the one or more optical carriers of the light paths; and assembling the data.

### BACKGROUND

With traffic demands continually increasing, driven by, among other things, video, cloud computing and mobility, optical network operators and/or service providers are confronted with a host of challenges to accommodate these traffic demands. One solution proposed to address this problem is the idea of super-channels, which permit multiple optical carriers to be bonded together (e.g., frequency-locked optical carriers, etc.) to enable channel data rates that exceed the 100 Gigabits/second (Gb/s) model. For example, super-channels may be configured to support channel data rates in the Terabit/second (Tb/s) realm.

### BRIEF DESCRIPTION OF THE DRAWINGS

FIG. 1A is a diagram illustrating an exemplary embodiment of an optical network having light-path aggregation capability;

FIG. 1B is a diagram illustrating components of an exemplary embodiment of a transmitting-side of one of the optical nodes depicted in FIG. 1A:

FIG. 1C is a diagram illustrating components of an exemplary embodiment of a receiving-side of one of the optical nodes depicted in FIG. 1A;

FIG. 2A is a diagram illustrating optical carriers of a channel traversing an optical network along a single light path;

FIG. 2B is a diagram illustrating optical carriers of a channel traversing the optical network along multiple light paths;

FIG. 3 is a diagram illustrating an exemplary scenario in which multiple light paths of a channel traverse the optical nodes of the optical network;

FIG. 4 is a diagram illustrating another exemplary scenario in which multiple light paths of a channel traverse the optical nodes of the optical network;

FIG. 5 is a diagram illustrating yet another exemplary scenario in which multiple light paths of a channel traverse the optical nodes of the optical network;

FIG. 6A is a diagram illustrating another exemplary scenario in which multiple light paths of a channel traverse the optical nodes of the optical network;

FIG. 6B is a diagram illustrating an exemplary channel management table;

FIG. 7 is a flow diagram illustrating an exemplary process for transmitting optical carriers of a channel along multiple light paths; and

FIG. 8 is a flow diagram illustrating an exemplary process for receiving the optical carriers of a channel that traversed multiple light paths.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

As traffic demands continually increase, optical networks must correspondingly increase their capacity. Optical networks, particularly long-haul optical networks, are now steering toward a super-channel architecture, in which a host of optical carriers are used and each optical carrier carries a fraction of the data of the super-channel. According to the super-channel architecture, the super-channel propagates from a source to a destination along a single light path.

According to an exemplary embodiment, an optical transport channel can be carried by multiple optical carriers in which the optical carriers can propagate along different light paths. That is, an optical carrier belonging to a particular transport channel may propagate along a light path different from another optical carrier belonging to the same transport channel.

According to an exemplary embodiment, the optical network includes light-path aggregation capability for optical transport channels. That is, the optical carriers belonging to a particular channel may aggregate at the end points of a light path. According to an exemplary embodiment, the aggregation capability includes, among other capabilities, a latency capability to manage latencies that may be created by virtue of optical carriers belonging to the same transport channel propagating along different light paths. According to such an embodiment, the latency of an optical carrier may be detected and re-timed, when needed. According to an exemplary implementation, buffers may be used, among other components, to manage the latencies of optical carriers.

According to an exemplary embodiment, an optical carrier of a transport channel may have its own data rate, modulation format, and/or light path provided that the total data rate of all of the optical carriers belonging to the transport channel meet the requirements of the optical transport channel.

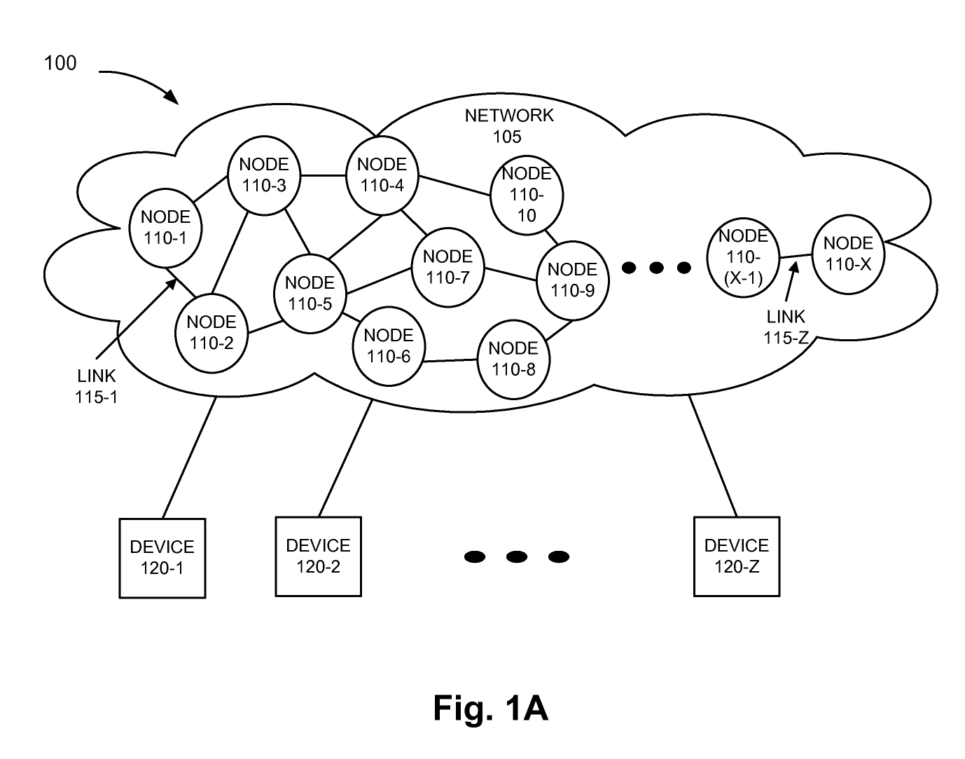

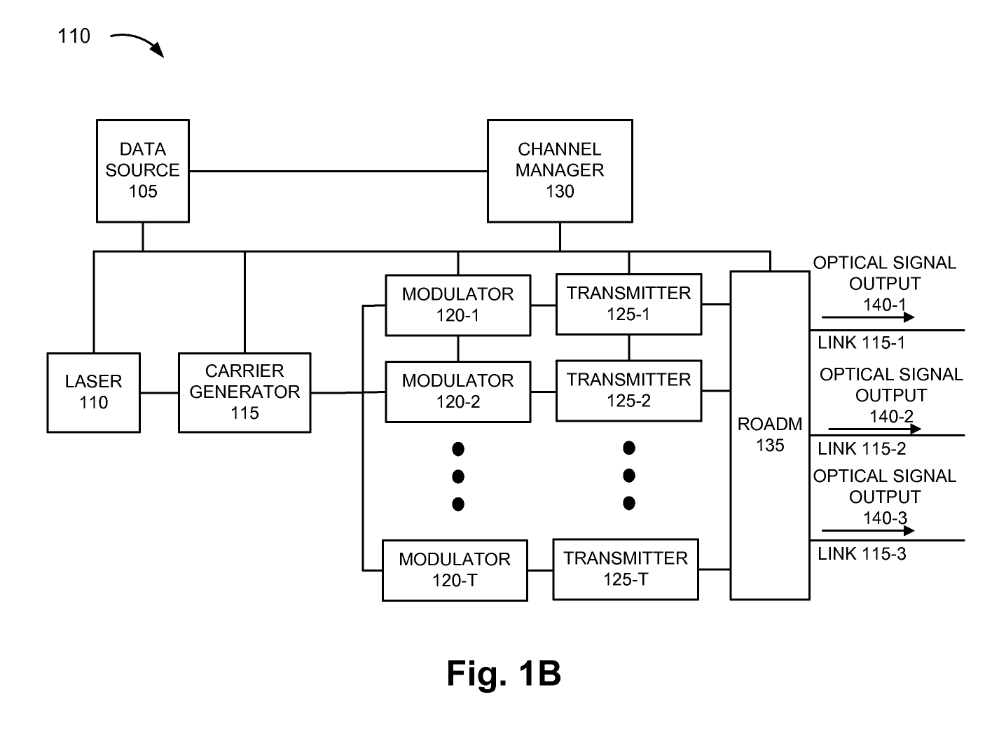

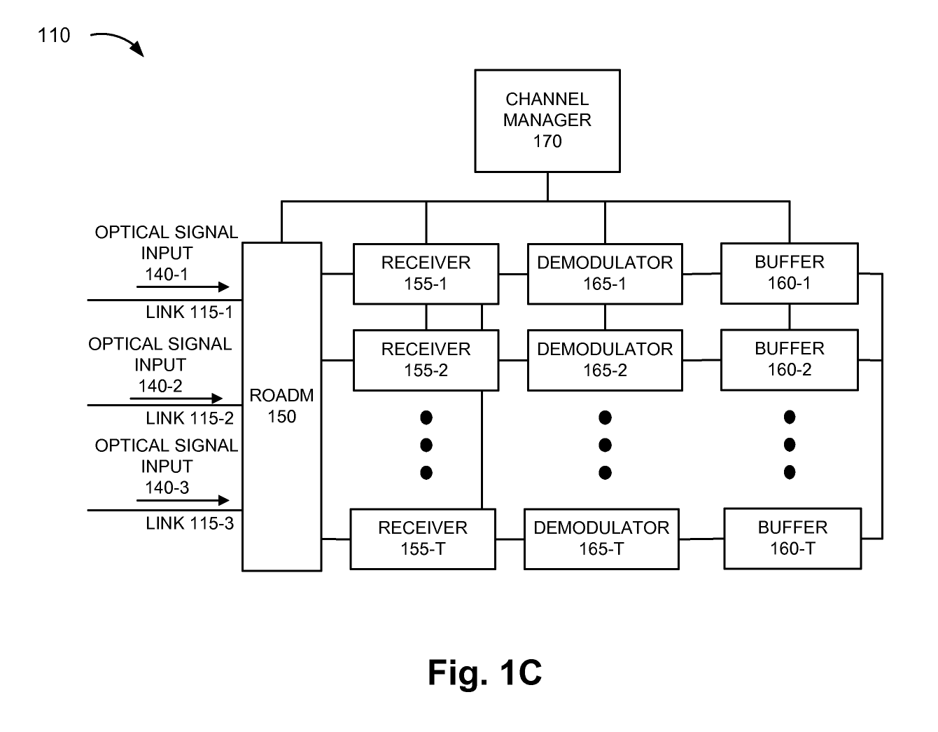

FIGS. 1A-1C are diagrams illustrating an exemplary embodiment of an optical network having light-path aggregation capability. As illustrated in FIG. 1A, an exemplary environment 100 includes an optical network 105 including optical node 110-1 through optical node 110-X, in which X>1 (referred to individually as optical node 110 or collectively as optical nodes 110), optical link 115-1 through optical link 115-Z, in which Z>1 (referred to individually as optical link 115 or collectively as optical links 115), and device 120-1 through device 120-Z, in which Z>1 (referred to individually as device 120 or collectively as devices 120). Devices 120 may be communicatively coupled to network 105 via various access technologies.

The number of devices (which includes optical nodes) and the configuration in environment 100 are exemplary and provided for simplicity. According to other embodiments, environment 100 may include additional devices, fewer devices, different devices, and/or differently arranged devices than those illustrated in FIG. 1A. For example, environment 100 may include intermediary devices (not illustrated) to permit communication between devices 120 and optical network 105.

Optical network 105 is an optical network. For example, optical network 105 may include a synchronous optical network. Optical network 105 may be implemented using various topologies (e.g., mesh, ring, etc.). According to an exemplary embodiment, optical network 105 is a long-haul optical network (e.g., long-haul, extended long-haul, ultra long-haul). According to other embodiments, optical network 105 is an optical network other than a long-haul optical network. According to an exemplary embodiment, optical network 105 is a Dense Wavelength Division Multiplexing (DWDM) network or a Wavelength-Division Multiplexing (WDM) network.

Optical node 110 is an optical site. For example, optical node 110 may take the form of an optical transmitting node, an optical receiving node, an optical regeneration site, or some other type of intermediary optical device between a source and a destination. Optical node 110 may be implemented as a WDM, a DWDM system, or an Optical Time Division Multiplexing (OTDM) system. Optical link 115 is an optical fiber that communicatively couples optical node 110 to another optical node 110. For example, optical link 115 may take the form of a nonzero dispersion-shifted fiber, etc.

Device 120 may include a device having the capability to communicate with a network (e.g., optical network 105), devices (e.g., optical node 110, etc.) and/or systems. For example, device 120 may correspond to a user device. The user device may take the form of a portable device, a handheld device, a mobile device, a stationary device, a vehicle-based device, or some other type of user device. Additionally, or alternatively, device 120 may correspond to a non-user device, such as, a meter, a sensor, or some other device that is capable of machine-to-machine (M2M) communication.

FIG. 1B is a diagram illustrating components of an exemplary embodiment of a transmitting-side of one of the optical nodes 110 depicted in FIG. 1A. As illustrated, optical node 110 includes a data source 105, a laser 110, a carrier generator 115, modulators 120-1 through 120-T, in which T>1 (referred to individually as modulator 120 or collectively as modulators 120), transmitters 125-1 through 125-T (referred to individually as transmitter 125 or collectively as transmitters 125), a channel manager 130, and a Reconfigurable Optical Add-Drop Multiplexer (ROADM)) 135. As further illustrated, optical links 115-1 through 115-3 are coupled to ROADM 135. The number of optical links 115 is exemplary and provided for simplicity.

The number of components and the configuration (e.g., connection between components) are exemplary and provided for simplicity. According to other embodiments, optical node 110 may include additional components, fewer components, different components, and/or differently arranged components than those illustrated in FIG. 1B. For example, the transmitting-side of optical node 110 may include a power source, an optical amplifier (e.g., Erbium Doped Fiber Amplifier (EDFA), Raman amplifier, etc.), digital signal processing (DSP) (e.g., forward error correction (FEC), equalization, filtering, etc.), an optical transceiver, etc.

Data source 105 may provide data that is to traverse optical node(s) 110 in optical network 105. Laser 110 may include a laser (e.g., a cooled laser). According to an exemplary embodiment, laser 110 may include a tunable laser (e.g., a Distributed Feedback (DFB) laser, an External-Cavity Laser (ECL), a Sampled Grating Distributed Bragg Reflector (SGDBR) laser, etc.). Carrier generator 115 may include components (e.g., a Photonic Integrated Circuit (PIC) or other known multicarrier generating architectures) to produce a multicarrier channel, such as a super-channel.

Modulators 120 may include optical modulators to provide a modulation format in terms of constellation (e.g., binary, quaternary, 8-ary, 16-ary, higher order constellations, etc.), manner of modulation (e.g. intensity, phase, frequency, polarization), etc. Transmitters 125 may include optical transmitters or transponders.

Channel manager 130 may include logic to manage transport channels and signaling. For example, unlike the super-channel design, optical carriers will traverse different light paths. Thus, channel manager 130 will manage the correlation between optical carriers, a transport channel, and multiple light paths. Channel manager 130 may also correlate performance and alarm information across all optical carriers.

As described further below, channel manager 130 may also manage failures pertaining to a transport channel. Unlike existing architectures in which all optical carriers traverse the same light path, a failure may impact a portion of the transport channel (e.g., one or more optical carriers traversing a light path), while other optical carriers of the transport channel traversing a different light path may not be impacted by the failure. Channel manager 130 may include one or multiple processors, microprocessors, multi-core processors, application specific integrated circuits (ASICs), controllers, microcontrollers, and/or some other type of hardware logic to perform the processes or functions described herein. ROADM 135 is a ROADM. ROADM 135 may include a colorless (e.g., any wavelength to any add/drop port), a directionless (e.g., any wavelength to any degree), and a contentionless (e.g., any combination of wavelengths to any degree from any port) architecture. ROADM 135 may support any portion of the optical spectrum, any channel bit rate, and/or any modulation format.

According to an exemplary process, as illustrated in FIG. 1B, the transmitting-side of optical node 110 may output optical signals (e.g., optical signal outputs 140-1 through 140-3) to optical links 115, which may traverse separate light paths in optical network 105. The number of output optical signals is exemplary and provided for simplicity.

FIG. 1C is a diagram illustrating components of an exemplary embodiment of a receiving-side of one of the optical nodes 110 depicted in FIG. 1A. As illustrated, optical node 110 includes a ROADM 150, receivers 155-1 through 155-T, in which T>1 (referred to individually as receiver 155 or collectively as receivers 155), buffers 160-1 through 160-T (referred to individually as buffer 160 or collectively as buffers 160), de-modulators 165-1 through 165-T (referred to individually as de-modulator 165 or collectively as de-modulators 165), and a channel manager 170. As further illustrated, optical links 115-1 through 115-3 are coupled to ROADM 150.

The number of components and the configuration (e.g., connection between components) are exemplary and provided for simplicity. According to other embodiments, optical node 110 may include additional components, fewer components, different components, and/or differently arranged components than those illustrated in FIG. 1B. For example, optical node 110 may include a power source, an optical amplifier (e.g., Erbium Doped Fiber Amplifier (EDFA), Raman amplifier, etc.), DSP, a transceiver, etc.

ROADM 150 may include a ROADM similar to that described above (i.e., ROADM 135). Receivers 155 may include optical receivers or transponders. Buffers 160 may include memory, such as, for example, cache or some other type of ultra-high speed memory to store data in the digital domain. Alternatively, buffers 160 may take the form of optical buffers. According to an exemplary embodiment, buffers 160 may be used to manage delay differences between optical signals of the same transport channel traversing difference light paths by storing the information (e.g., data) pertaining to one or more optical carriers. De-modulators 165 may include optical modulators that complement modulators 120.

Channel manager 170 may include logic to manage transport channels and signaling. Channel manager 170 will manage the correlation between optical carriers, a transport channel, and multiple light paths. Channel manager 170 may manage the assembly of the optical carriers of a transport channel and delay differences between the optical carriers. Channel manager 170 may also correlate performance and alarm information across all optical carriers.

Channel manager 170 may also manage failures pertaining to a transport channel. For example, channel manager 170 may identify when an optical carrier(s) may need to be re-transmitted (e.g., due to the failure) by a source or a transmitting optical node 110. Channel manager 130 may include one or multiple processors, microprocessors, multi-core processors, application specific integrated circuits (ASICs), controllers, microcontrollers, and/or some other type of hardware logic to perform the processes or functions described herein.

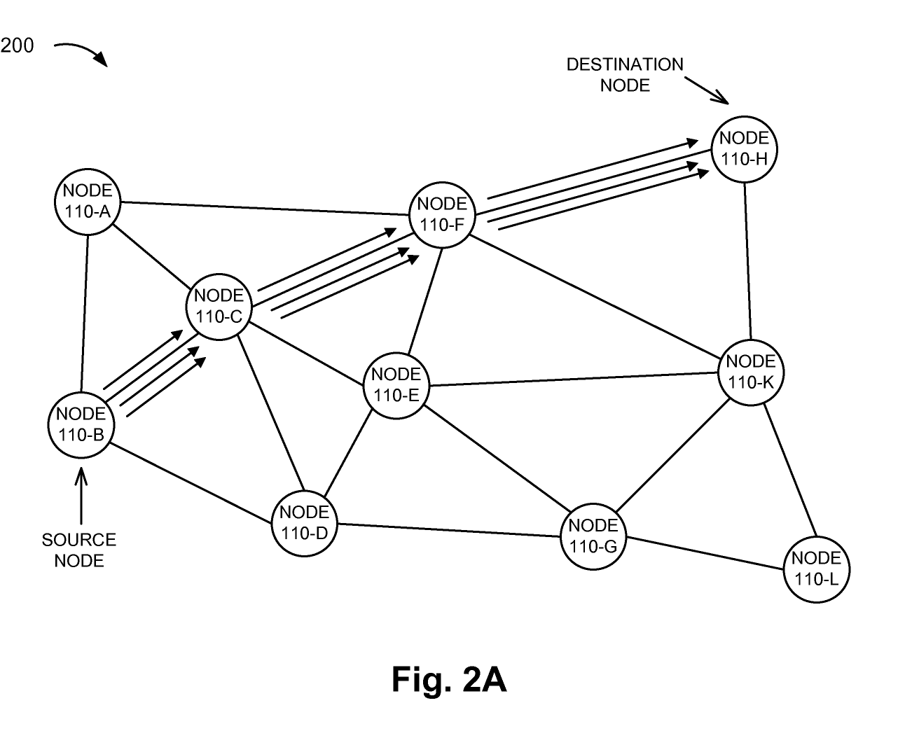

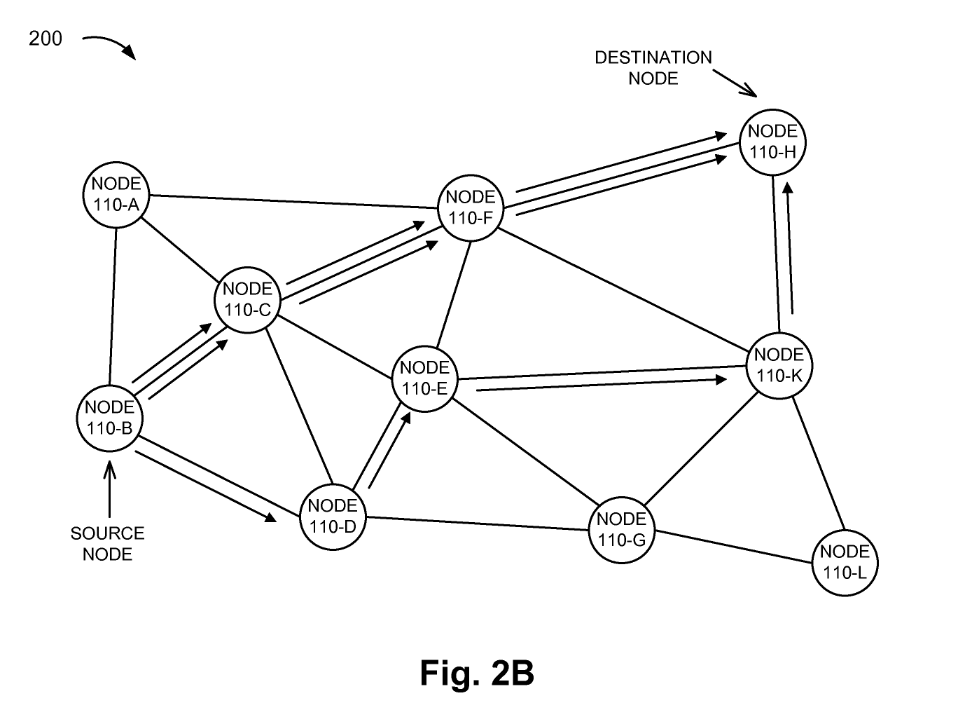

As previously described, according to exemplary embodiments, a channel can be carried by multiple optical carriers in which the optical carriers can propagate along different light paths via optical nodes 110. This is in contrast to conventional approaches. For example, as illustrated in FIG. 2A, optical carriers of a channel traverse an optical network 200 along a single light path (e.g., nodes 110B-C-F-H). However, as illustrated in FIG. 2B, according to an exemplary embodiment, optical carriers of a channel traverse optical network 200 along multiple light paths, in which a portion of the channel traverses via nodes 110B-C-F-H and another portion of the channel traverses nodes 110B-D-E-K-H.

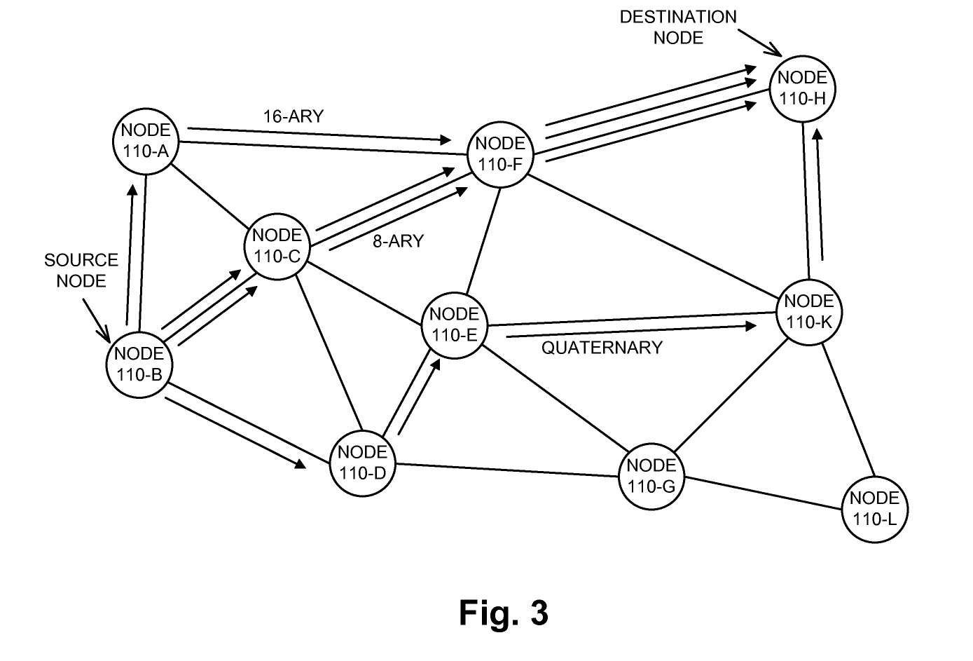

FIG. 3 is a diagram illustrating an exemplary scenario in which multiple light paths of a channel traverse optical nodes 110 of optical network 200. According to this scenario, it may be assumed that a channel between optical nodes 110B and H is needed. As illustrated in FIG. 3, a channel traverses optical network 200 along multiple light paths via optical nodes 110 (e.g., nodes 110B-A-F-H; nodes 110B-D-E-K-H; and nodes 110B-C-F-H) having different modulation (e.g., 16-ary, 8-ary, and quaternary).

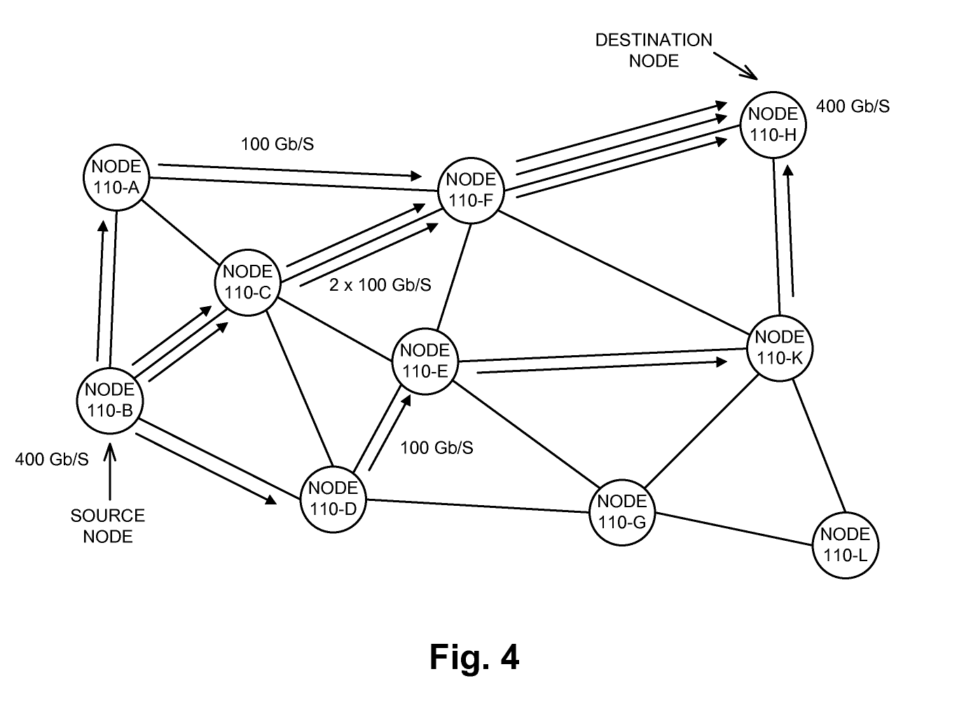

FIG. 4 is a diagram illustrating another exemplary scenario in which multiple light paths of a channel traverse optical nodes 110 of optical network 200. According to this scenario, it may be assumed that a 400 Gb/s channel between optical nodes 110B and H is needed. However, optical network 200 does not have enough optical carriers along a single light path (e.g., nodes 110B-C-F-H) to support this data rate.

According to an exemplary implementation, the 400 Gb/s channel traverses optical network 200 along multiple light paths. According to this scenario, as illustrated, the 400 Gb/s channel is composed of one 100 Gb/s optical carrier that traverses optical nodes 110B-A-F-H, two 100 Gb/s optical carriers that traverse optical nodes 110B-C-F-H, and one 100 Gb/s optical carrier that traverses optical nodes 110B-D-E-K-H.

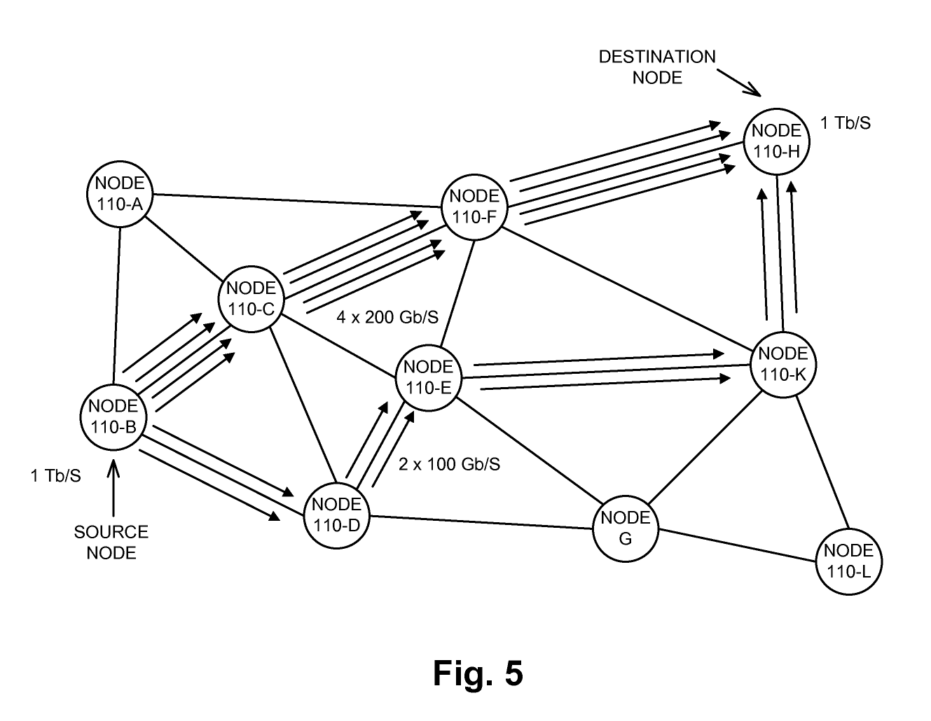

FIG. 5 is a diagram illustrating yet another exemplary scenario in which multiple light paths of a channel traverse optical nodes 110 of optical network 200. According to this scenario, it may be assumed that a 1 Tb/s channel between optical nodes 110B and H is needed. However, optical network 200 does not have enough optical carriers along a single light path (e.g., nodes 110B-C-F-H) to support this data rate.

According to an exemplary implementation, the 1 Tb/s channel traverses optical network 200 along multiple light paths. According to this scenario, the 1 Tb/s channel is composed of different data rates traversing different light paths. For example, the 1 Tb/s channel is composed of four 200 Gb/s optical carriers that traverse optical nodes 110B-C-F-H, and two 100 Gb/s optical carrier that traverse optical nodes 110B-D-E-K-H (e.g., since the distance is much longer than the light path of optical nodes B-C-F-H).

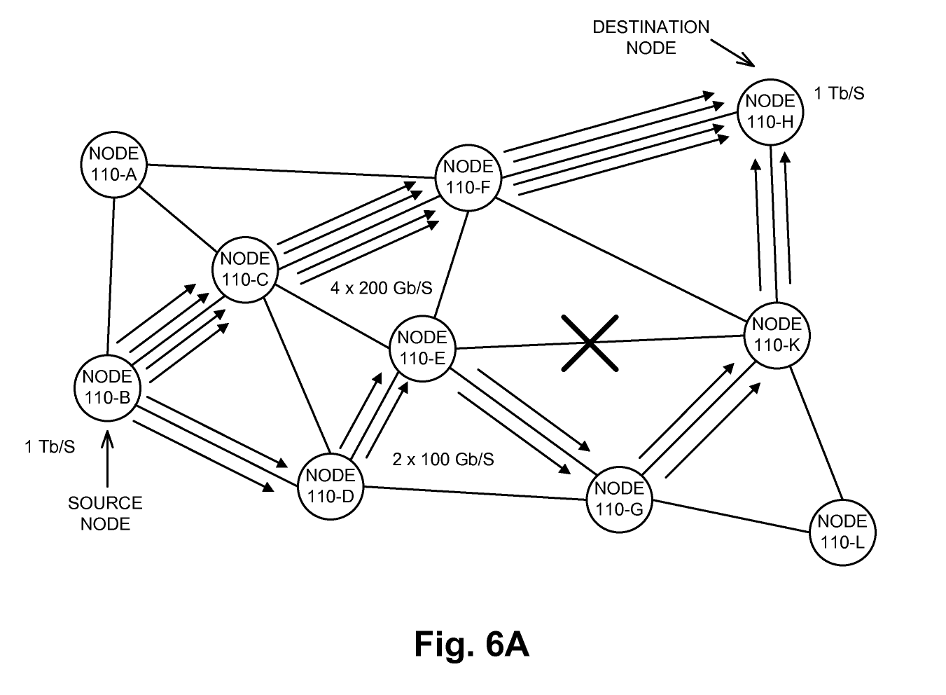

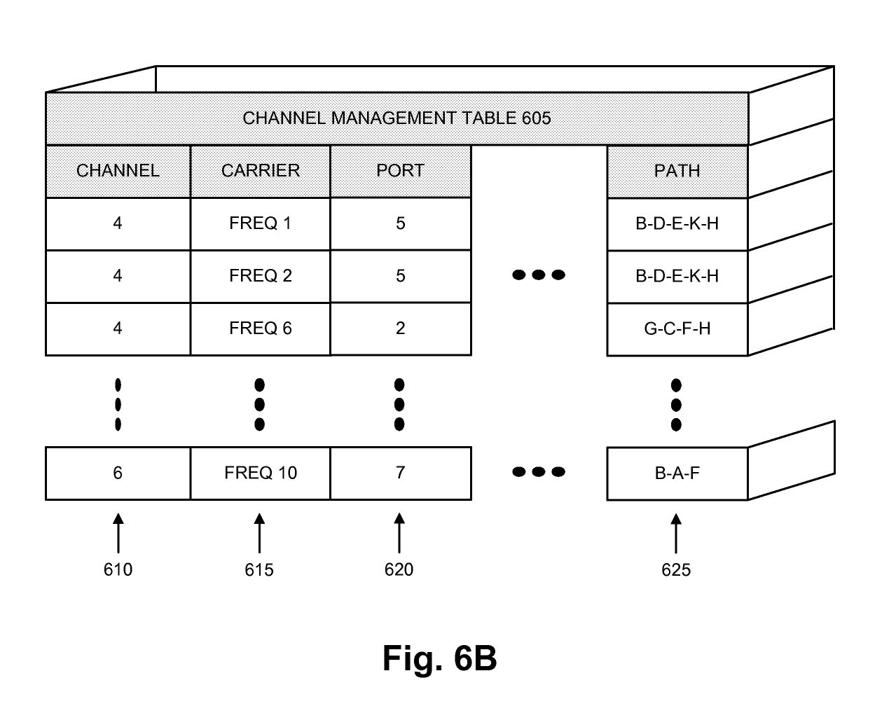

FIG. 6 is a diagram illustrating another exemplary scenario in which multiple light paths of a channel traverse optical nodes 110 of optical network 200. According to this scenario, it may be assumed that a 1 Tb/s channel is composed of four 200 Gb/s optical carriers that traverse optical nodes 110B-C-F-H, and two 100 Gb/s optical carriers that traverse optical nodes 110B-D-E-K-H. Subsequently, an optical link failure occurs between optical nodes 110E and K.

According to an exemplary implementation, destination node 110-H and/or intermediary node 110-E may transmit a control signal to source node 110-B to indicate the existence of the optical link failure. When the control signal is received, channel manager 130 of source node 110-B may identify the two 100 Gb/s optical carriers that need to be re-transmitted. According to an exemplary implementation, channel manager 130 may use a table or other data structure that stores information pertaining to outbound channels.

FIG. 6B illustrates an exemplary channel management table 605. As illustrated, channel management table 605 may include, among other fields, a channel field 610 that identifies optical channels, a carrier field 615 that identifies a frequency (e.g., a center frequency or a reference frequency), a port field 620 that identifies a port pertaining to ROADM 135, and a path field 625 that identifies a path associated with an optical carrier. According to other implementations, channel management field 605 may include additional field(s), fewer field(s), and/or different field(s) than those illustrated. For example, channel management table 605 may include fields pertaining to the total data rate of the channel, the data rates pertaining to each optical carrier of a channel, etc.

According to this scenario, channel manager 130 may identify channel 4, port 5, frequencies 1 and 2, and light path B-D-E-K-H, as this information pertains to the optical carriers that failed to reach destination node 110-H due to the optical link failure. Since the 1 Tb/s channel comprised of optical carriers traversing distinct light paths, source node 110-B needs to only compensate for 200 Gb/s of the 1 Tb/s channel instead of the entire 1 Tb/s that would otherwise be needed when all optical carriers of a channel traverse the same light path.

Based on resource availability, channel manager 130 may assign an optical carrier(s) to another light path (i.e., a working path) to compensate for that portion of the transport channel that did not reach destination node 110-H. For example, as illustrated in FIG. 6A, channel manager 130 may use two 100 Gb/s optical carriers via optical nodes 110B-D-E-G-K-H to compensate for the failure.

It may be assumed that delay exists between the optical carriers of the 1 Tb/s channel reaching destination node 110-H. However, channel manager 170 of destination node 110-H manages these delay differences based on its logic and buffers 160.

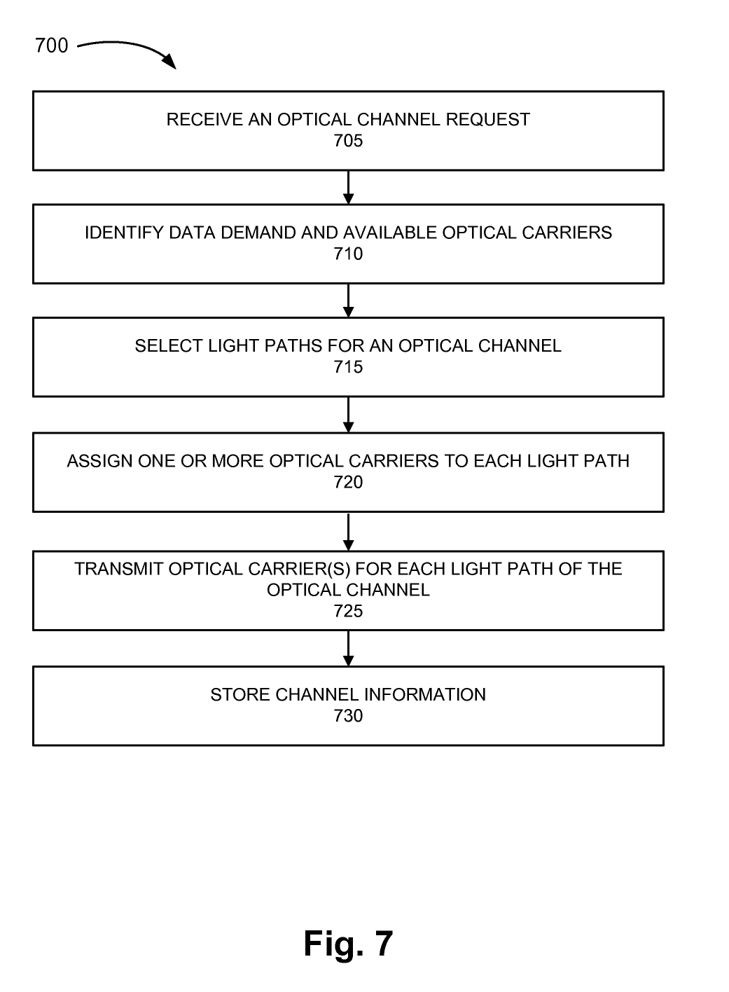

FIG. 7 is a flow diagram illustrating an exemplary process 700 for transmitting optical carriers of a channel along multiple light paths. Process 700 may be performed by optical node 110. According to an exemplary implementation, channel manager 130, in combination with other components of optical node 110, performs process 700 when optical node 110 is a source or a transmitting node.

In block 705, optical node 110 receives an optical channel request. The optical channel request includes the data rate needed for the optical channel and the destination node 110. The optical channel request may include other information, such as, quality of service information, etc. Channel manager 130 receives pertinent information (e.g., data rate, destination node, etc.) pertaining to the optical channel request to allow channel manager 130 to allocate resources for the multi-light path channel.

In block 710, channel manager 130 identifies the data demand pertaining to the optical channel request and available resources. At least based on this information, channel manager 130 is able to select the light paths and optical carriers (blocks 715 and 720). Depending on the data demand and available resources, channel manager 130 may select optical carriers of the channel to each have their own data rate, modulation format, and/or light path. For example, channel manager 130 may select multiple light paths in which each light path includes one or more optical carriers. Additionally, or alternatively, as previously described, data rates of different optical carriers may be set to different values to optimize spectral efficiency according to the distance of the light-paths. Additionally, or alternatively, optical carriers may differ in modulation format. In this way, left-over capacities (i.e., resources) of light paths may be used and optical bandwidth waste can be minimized.

In block 725, transmitters 125 transmit the selected optical carriers via ROADM 135 along the light paths selected by channel manager 130. In block 730, channel manager 130 stores channel information (e.g., in channel management table 605) pertaining to the received optical channel request and/or the resources allocated to satisfy the optical channel request.

Although FIG. 7 illustrates an exemplary process 700 for transmitting multiple optical carriers of a same channel over multiple light paths, according to other implementations, process 700 may include additional operations, fewer operations, and/or different operations than those illustrated in FIG. 7 and described herein.

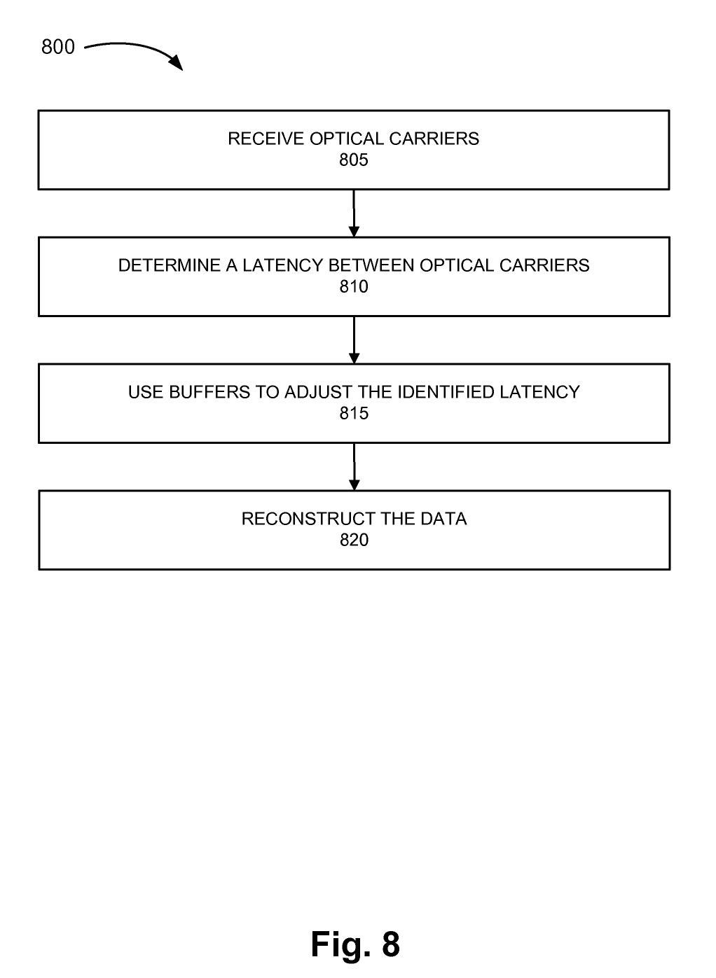

FIG. 8 is a flow diagram illustrating an exemplary process for receiving the optical carriers of a channel that traversed multiple light paths. Process 800 may be performed by optical node 110. According to an exemplary implementation, channel manager 170, in combination with other components of optical node 110, performs process 800 when optical node 110 is a receiving or a destination node. It may be assumed that optical node 110 (e.g., channel manager 170) has knowledge of the light paths and/or optical carriers belonging to a particular channel based on control signaling (e.g., from a source or a transmitting node 110).

In block 805, optical node 110 receives optical carriers of a channel that traversed different light paths. For example, the optical carriers may be received via ROADM 150 and/or receivers 155.

In block 810, optical node 110 determines the latency between the optical carriers. For example, according to an exemplary implementation, the source or the transmitting node 110 may insert markers into the optical carriers that may be used to determine the latency between the optical carriers by identifying and interpreting the markers included in the optical carriers when the optical carriers are received by optical node 110. Channel manager 170 may measure and identify the latency between optical carriers based on the markers.

In block 815, optical node 110 uses buffer(s) 165 to adjust the identified latency. For example, optical node 110 may convert the optical signal into the digital domain. By way of example, the data may take the form of Asynchronous Transfer Mode (ATM) cells, Internet Protocol (IP) packets, frames, etc.). Channel manager 170 may identify which packets, cells, frames, etc., are stored in buffers 165 based on the identified latency. Alternatively, when buffers 165 take the form of optical buffers, the light may be stored. In this way, an earlier optical carrier or data relative to another optical carrier or may be stored in buffer 165. According to an exemplary implementation, optical node 110 may include a buffer 165 for each optical carrier to adjust latencies that exist.

In block 820, optical node 110 reconstructs the data. For example, channel manager 170 assembles the data (e.g., based on sequence numbers, or other known techniques) with respect to the buffered data and other incoming data received from other optical carriers. The assembled data may be used by a particular service, pushed to an end user, etc.

Although FIG. 8 illustrates an exemplary process 800 for receiving multiple optical carriers of a same channel over multiple light paths, according to other implementations, process 800 may include additional operations, fewer operations, and/or different operations than those illustrated in FIG. 8 and described herein.

According an exemplary embodiment, described herein, data management at the transport layer may provide additional flexibility relative to existing approaches based on light-path aggregation.

The foregoing description of implementations provides illustration, but is not intended to be exhaustive or to limit the implementations to the precise form disclosed. Accordingly, modifications to the implementations described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks are described with regard to the processes illustrated in FIGS. 7 and 8, the order of the blocks may be modified in other implementations. Further, non-dependent blocks may be performed in parallel. Additionally, with respect to other processes described in this description, the order of operations may be different according to other implementations, and/or operations may be performed in parallel.

An embodiment described herein may be implemented in many different forms. For example, a process or a function may be implemented as “logic” or as a “component.” The logic or the component may include hardware (e.g., one or more processors, multi-core processors, etc.), as previously described.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, operation, or instruction described in the present application should be construed as critical or essential to the embodiments described herein unless explicitly described as such.

What is claimed is:

1. A method comprising:
receiving an optical channel request;
identifying a data demand of the optical channel request;
identifying available resources for satisfying the optical channel request;
selecting light paths to a destination based on the identified available resources, wherein each light path is distinct from a source to the destination;
selecting one or more optical carriers for each light path based on the identified available resources; and
optically transmitting data pertaining to the optical channel request based on the selected light paths, wherein each selected optical carrier of each light path carries a portion of the data and a total of the one or more optical carriers associated with the light paths collectively carry an entire portion of the data.

2. The method of claim 1, wherein one or more of the light paths is a super-channel.

3. The method of claim 1, further comprising:
generating the one or more optical carriers of one of the light paths;
generating the one or more optical carriers of another one of the light paths,
wherein the one or more optical carriers of the one of the light paths have at least one of a data rate or a modulation format that is different from the one or more optical carriers of the other one of the light paths.

4. The method of claim 1, further comprising:
storing transport channel information pertaining to the one or more optical carriers of each light path.

5. The method of claim 1, further comprising:
calculating a distribution of the data demand across the one or more optical carriers of the light paths; and
assigning a data rate for each of the one or more optical carriers of each light path based on the calculating.

6. The method of claim 1, further comprising:
inserting markers into the optically transmitted data; and
using the markers to identify latencies between the selected one or more optical carriers of the selected light paths.

7. The method of claim 1, further comprising:
receiving the one or more optical carriers of two or more of the light paths at the destination;
identifying a latency between the one or more optical carriers of the two or more of the light paths; and
adjusting the latency between the one or more optical carriers of the two or more of the light paths based on a buffering of the portion of the data.

8. The method of claim 7, wherein the identifying the latency comprises:
identifying markers inserted into the one or more optical carriers of the two or more light paths; and
measuring the latency between the markers associated with the one or more optical carriers of the two or more light paths.

9. The method of claim 7, further comprising:
assembling the data pertaining to the optical channel request at the destination based on the adjusting.

10. The method of claim 1, further comprising:
identifying when at least one of the one or more optical carriers of at least one of the light paths is not received at the destination; and
optically retransmitting the at least one of the one or more optical carriers to the destination, wherein a retransmission has a light path different from an original transmission associated with the at least one of the one or more optical carriers.

11. An optical node comprising:
one or more Reconfigurable Optical Add-Drop Multiplexers;
one or more multi-carrier generators; and
a optical transport channel manager configured to:
receive an optical channel request;
identify a data demand of the optical channel request;
identify available resources for satisfying the optical channel request;
select light paths toward a destination based on the identified available resources, wherein each light path is distinct from a source to the destination; and
selecting one or more optical carriers for each light path based on the identified available resources; and
one or more optical transmitters configured to:
optically transmit data pertaining to the optical channel request based on the selected light paths, wherein each selected optical carrier of each light path carries a portion of the data and a total of the one or more optical carriers associated with the light paths collectively carry an entire portion of the data.

12. The optical node of claim 11, wherein the optical transport channel manager is further configured to:
calculate a distribution of the data demand across the one or more optical carriers of the light paths; and
assign a data rate for each of the one or more optical carriers of each light path based on the calculating.

13. The optical node of claim 11, wherein the optical transport channel manager is further configured to:
store transport channel information pertaining to the one or more optical carriers of each light path, wherein one or more of the light paths comprises a super-channel.

14. The optical node of claim 11, wherein the one or more optical transmitters are further configured to:
optically transmit the data in which one or more optical carriers of one of the light paths have at least one of a data rate or a modulation format that is different from one or more optical carriers of another one of the light paths; and
optically transmit the data to include latency markers.

15. The optical node of claim 14, further comprising:
one or more optical receivers configured to:
optically receive the one or more optical carriers of the light paths; and the optical transport channel manager is further configured to:
identify a latency between one or more optical carriers of two or more of the light paths based on the latency markers; and
adjust the latency between the one or more optical carriers of the two or more of the light paths based on a buffering of the portion of the data.

16. The optical node of claim 15, wherein the optical transport channel manager is further configured to:
assemble the data received by the one or more optical receivers pertaining to an optical channel of the received light paths.

17. The optical node of claim 15, further comprising:
buffers; and the optical transport channel manager is further configured to:
use the buffers to store the portion of the data based on the identified latency.

18. A method comprising:
receiving an optical channel request;
identifying a demand of an optical channel request;
identifying available resources;
selecting light paths and one or more optical carriers for each light path based on the identified available resources, wherein at least one of the light paths is a super-channel including optical carriers; and
optically transmitting data pertaining to the optical channel request based on the selected light paths, wherein each selected optical carrier of each light path carries a portion of the data and a total of the one or more optical carriers associated with the light paths collectively carry an entire portion of the data.

19. The method of claim 18, wherein one or more optical carriers of one of the light paths have at least one of a data rate or a modulation format that is different from one or more optical carriers of another of the light paths.

20. The method of claim 18, further comprising:
receiving the one or more optical carriers of the light paths;
identifying a latency between the one or more optical carriers of one of the light paths relative to one or more other light paths;
adjusting the latency; and
assembling the data.
